(19) United States
(12) Patent Application Publication
(10) Pub. No.: US 2015/0173856 A1
(43) Pub. Date: Jun. 25, 2015

(54) INTRA-ORAL VIBRATING OTHODONTIC DEVICES

(71) Applicant: ORTHOACCEL TECHNOLOGIES INC., Bellaire, TX (US)

(72) Inventors: Michael K. LOWE, Houston, TX (US); Alex BEVLY, Houston, TX (US); Glenn SPAULDING, Houston, TX (US)

(21) Appl. No.: 14/612,081

(22) Filed: Feb. 2, 2015

Related U.S. Application Data
(63) Continuation-in-part of application No. 12/615,049, filed on Nov. 9, 2009, now Pat. No. 9,028,250.
Application No. 12/615,049 is a continuation-in-part of application No. 11/773,849, filed on Jul. 5, 2007.
(60) Provisional application No. 61/935,148, filed on Feb. 3, 2014.
(60) Provisional application No. 62/042,115, filed on Aug. 26, 2014.
(60) Provisional application No. 60/906,807, filed on Mar. 14, 2007.

(51) Int. Cl. A61C 7/00

(52) U.S. Cl. CPC A61C 7/008

(57) ABSTRACT

A variety of improvements to the vibrating devices for orthodontic remodeling are provided, including a completely intra-oral vibrating bite plate with very thin cross section, and an intra-oral device with snap in electronics that allows the same electronics case to be used with a variety of bite plate sizes.

### PRIOR RELATED APPLICATIONS

This application is a Continuation-in-Part of US20080227046 (Ser. No. 11/773,849), filed Jul. 5, 2007, which claims priority to 60/906,807, filed Mar. 14, 2007, as well as US20100055634 (Ser. No. 12/615,049), filed Nov. 9, 2009, each of which is incorporated in its entirety herein for all purposes. This application is also a Continuation-in-Part of 61/935,148, filed Feb. 3, 2014 and 62/042,115, filed Aug. 26, 2014. Each reference cited above is incorporated herein in its entirety for all purposes.

### FIELD OF THE DISCLOSURE

The disclosure relates to completely intra-oral vibrating dental devices for correcting malocclusion.

### BACKGROUND OF THE DISCLOSURE

Orthodontics is a dental specialty that treats malocclusion through the movement of teeth as well as the control and modification of facial growth. This process is usually accomplished by using a continuous mechanical force to induce bone remodeling, thereby enabling the teeth to move to a better position. In this approach, orthodontic appliances provide a continuous static force to the teeth via an archwire connected to brackets affixed to each tooth or via a removable appliance such as an aligner, or some similar accessory, that fits over the dentition. As the teeth slowly move due to the force, the force is dissipated. The archwires are adjusted to add additional force and to continue the desired tooth movement. Although effective, this widely accepted approach takes about twenty-four months on average to achieve success.

Researchers have long postulated that a pulsating force might also be used to move teeth more rapidly and to ease the discomfort of traditional orthodontics, but Mao was probably the first to prove that the use of cyclic forces could speed bone remodeling in rabbits (see U.S. Pat. No. 6,684,639, U.S. Pat. No. 6,832,912, U.S. Pat. No. 7,029,276). Certain dynamic loading patterns (cycling force with rest periods) were shown to greatly increase bone formation compared to basic dynamic loading. Inserting rest periods is now known to be especially efficacious as it allows mechano-sensitivity to be restored to the bone tissue. A point of diminishing returns is reached within each loading session. Therefore, intermittently loading cyclic force can increase the rate of bone formation significantly. However, Mao studied rabbit cranial suture closure and facial lengthening, and his results, while suggestive, could not be presumed to apply to humans. In addition, the Mao device was completely unsuitable for clinical testing.

U.S. Pat. No. 4,244,688, U.S. Pat. No. 4,348,177, and U.S. Pat. No. 4,382,780 by Kurz describe devices used to vibrate the teeth during orthodontic treatment, although each uses a different means of applying a vibration. The U.S. Pat. No. 4,244,688 patent employs a cumbersome external power source to power one to four small motors, whereas U.S. Pat. No. 4,348,177 uses pulsating fluids moved with the chewing motion of the jaw, and U.S. Pat. No. 4,382,780 uses a radio and speaker to set up a vibration. These devices are mounted on a bulky headgear that surrounds the head and are connected directly to the teeth by its intra-oral portions. The devices are cumbersome, difficult to construct, and expensive. Furthermore, these devices also provide realignment forces in addition to the vibration, and thus are intended for 24-hour usage.

U.S. Pat. No. 5,030,098 by Branford describes a hand-held device that simulates chewing in order to treat periodontal disease by increasing blood flow to the gums. The mouthpiece has a perforated malleable plate such that biting of the mouthpiece results in the plate adapting to the user's bite, which varies with each user. The external vibrator imparts motion to the mouthpiece and thus the user's teeth. The device, however, uses an external power source and vibrator. Further, the bite plate is brass, and is very unpleasant to bite on.

U. S. Pat. No. 5,967,784 by Powers describes a similar device to that described by Branford. It too is a hand-held tooth vibrator that is simple and has an exterior motor housing connected to a vibrating interdental mouthpiece portion for gripping between the teeth of the patient. The exterior housing contains a battery and a switch for selectively operating a motor with an off-center weight attached to the motor rotating shaft for creating a high frequency vibration that vibrates the entire device. The mouthpiece is disposable, making the system affordable and more convenient to use. The patent teaches using the device to alleviate pain by inserting the interdental mouthpiece between the teeth and clenching and releasing the teeth over the mouthpiece, in an attempt to engage as many teeth as possible in the transmitted vibrations. The vibration is believed to alleviate discomfort by increasing blood flow.

The devices of Branford and Powers seem superficially similar to those of the devices herein. However, there is no recognition in either patent that the vibratory device can be used for alveolar bone remodeling or more rapid tooth movement. Furthermore, the shape of the bite plate in each case is a very flat U-or Y-shaped member that is less effective for remodeling dentoalveolar bone. Additionally, the vibration is not optimized in frequency and amplitude for bone remodeling. Finally, neither device is entirely intra-oral, and the extra-oral component may cause drooling and inhibit patient compliance. The extra-oral component may also lead to inhibition about use of the device in certain settings. All of these shortcomings reduce the effectiveness of these devices for craniofacial remodeling uses.

U.S. Pat. No. 6,632,088 describes a bracket with powered actuator mounted thereto to provide vibration, but this device is cumbersome, and thus may affect patient comfort and ultimately patient acceptance of the device. Further, the device locks to the bracket and archwire, and vibration of the tooth through the bracket is less than optimal, causing wear to the tooth enamel and causing discomfort.

WO2007116654 describes another intra-oral vibrating mouthpiece, but the mouthpiece is complex, designed to fit over the teeth and will be expensive to manufacture. Further, to the extent that this device vibrates the brackets, it suffers from the same disadvantages above.

OrthoAccel Technologies Inc., invented the first commercially successful dental vibrating device, as described in US20080227046, designed to apply cyclic forces to the dentition for accelerated remodeling purposes. Both intra-oral and extra-oral embodiments are described in US20080227046, each having processors to capture and transmit patient usage information. The bite plate was specially designed to contact occlusal as well as lingual and/or facial surfaces of the dentition, and thus was more effective than any prior art devices in conveying vibrational forces to the teeth.

Further, the device was tested in clinical trials and has been shown to speed orthodontic remodeling as much as 50%, and is truly a breakthrough in orthodontic technology. Finally, the device is slim, capable of hands free operation, lacks the bulky head gear of the prior art devices, and has optimized force and frequency for orthodontic remodeling and only requires 20 minutes usage per day for clinical efficacy. Thus, its comfort level and compliance was also found to be high, with patients reporting that they liked the device, especially after the motor was redesigned to be quieter and smoother, as described in US2010055634 et seq.

In fact, this device has been marketed as AcceleDent™ in Australia, the United Kingdom, Europe, China, South Korea, Japan, Kenya, and the United States and has achieved remarkable commercial success since its recent introduction (2009). AcceleDent™ represents the first successful clinical approach to accelerate orthodontic tooth movement by modulating bone biology in a non-invasive and non-pharmacological manner.

However, further improvements in the above device are always beneficial, and this application addresses some of those improvements.

### SUMMARY OF THE DISCLOSURE

The disclosure generally relates to improved devices for dental remodeling through the application of cyclic forces. A completely intra-oral vibrating bite plate is provided herein. The device has numerous benefits over prior art extra-oral drive embodiments, namely that saliva egress is virtually eliminated with these designs. Additionally, compliance is expected to improve because the device barely affects aesthetics during use, being completely discrete. Further, a simplified model without data capture and transmission ability is expected to reduce cost, and can also drive patient acceptance.

U.S. Pat. No. 8,152,521 by Yamamoto does describe an intra-oral vibrating orthodontic device. However, that device is an aligner with vibrating motor sandwiched between inner and outer layers of plastic, molded to fit the teeth and apply orthodontic forces in addition to the vibration. Further, the vibrator is illustrated on the central facial surface of the aligner (over the incisors), thus negatively impacting both comfort and aesthetics. Finally, the vibratory forces used therein (˜50 g) are much too strong for human use, and are predicted to lead to increased root resorption when combined with aligning forces.

In contrast, the claimed device uses forces optimized to speed orthodontic remodeling without causing root resorption as proven in a clinical trial (1-400 Hz, 0.1-0.5 N, or 20-40 Hz and 0.2-0.3 N or most preferred is 30 Hz, 0.2-0.25 N). Further, the vibrators are hidden on either occlusal or lingual surfaces of the bite plate, and thus are not visible in use and provide more comfort since there is more space in these regions.

In a first embodiment, the entire device is contained in a thin, roughly planar, dentition shaped plate that is hermetically sealed. In this variation, the electronics are placed right on the core of the bite plate, preferably into depressions provided therein, and the entire device sealed for use. The core can be a single layer with electronics on top, or can be two layers—an upper and lower core layers that sandwich the electronics therebetween, protecting them from damage. Since the electronics will be subject to bite pressures, if only a single core is used, it is preferred to place the components on the buccal (cheek) or lingual (tongue) edges. Labial (adjacent the lips) is less preferred as detracting from the aesthetics and being prone to saliva egress, but can be done if the components are sufficiently small as to not displace the lips (e.g., <3 or <2 mm depth).

The device is then wirelessly activated with an external power source, such as that described in US20090058361 and all programming components are also external. However, these can also be omitted, and a simple device with limited life span (battery or charged capacitor) and on/off mechanism can be provided at lower cost.

In another embodiment, the electronics are centrally located inside a housing that is positioned lingually (e.g. inside the previously hollow U of the U-shaped bite plate and positioned inside the teeth between the tongue and palate).

In yet another embodiment, this lingual housing reversibly snap fits to the U-shaped bite plate, and thus the same electronics components can be used with many differently sized bite plates (see e.g., FIGS. 2, 7, 8, 9).

In yet another embodiment, the bite plate is replaced with an aligner (or a pair of aligners), thus, the device provides both orthodontic forces and micropulses, but the vibrators can be disconnected for maximum comfort during daily use.

Another embodiment provides an improved bite plate design that accommodates the various bite configurations that a patient may have. Thus, a wedge-shaped bite plate sloping with increased vertical dimension from anterior to posterior is provided for patients with a deep-bite malocclusion; a wedge-shaped bite plate sloping with increased vertical dimension from posterior to anterior is provided for patients with an open-bite; and a flat bite plate is provided for patients with malocclusion that does not involve an open-bite or deep-bite (see also FIG. 3).

In another embodiment, the improved vibrator has a more stable vibrator with improved performance characteristics of decreased sound and low variability frequency and force. In particular, the improved vibrator has a noise level less than 55 dB when measured at 6 inches, a frequency at 20-40 Hz, with a variance of only 2 Hz, and a force of 0.1-0.5 Newtons, with a variance of ±0.05 N.

In one embodiment of the intra-oral device, a battery or charged capacitor is also placed on the bite plate, together with on/off switches on the plate, which can be, for example, activated by biting the plate. In other embodiments, however, the battery or charged capacitor is omitted, and instead the device is wirelessly powered, e.g., with RF or other field, thus eliminating both the battery and the on/off switch, but necessitating a receiver in place of the battery.

In other embodiments, motors are activated by snap fitting the motor housing to the snap fit attachment, thus also eliminating any exterior buttons or activation means. In another embodiment, an accelerometer is included inside the motor housing, such that the device is activated by shaking or tapping. Current accelerometer are readily available in the 1-2 mm size, and submicron accelerometers are becoming available.

For patient comfort, the smallest means of providing vibration are employed on the intra-oral device. A large number of very small vibrating motors are available, as shown in the table below, but piezoelectric motors may be preferred due to the small size, and off-set weighted motors may be preferred due to low cost and availability. Particularly preferred are the substantially planar motors where the vibration is substantially parallel to the substrate (e.g., U.S. Pat. No. 5,554,971, U.S. Pat. No. 5,780,958, US 20090224616, US20080129130, US20070103016, WO0178217, each incorporated by reference).

| Company | Catalog | Size | Specifications |
|---|---|---|---|
| ELLIPTEC AG ™ | NA | 10 × 3 × 2 mm | 3-6 volts |
| | See US6870304 | | piezoelectric motor |
| SURPLUS | MF820 | 8 × 4 mm | 1.5 to 4.5 VDC |
| TRADERS ™ | | (0.315 × 0.1575 inches) | weighted shaft |
| SURPLUS | MF918 | 0.45 × 0.16 inches | 1 VDC to 5 VDC |
| TRADERS ™ | | | 18 ohms |
| | | | Weighted shaft |
| MOTOROLA ™ | G13566 | 0.44 × 0.18 inches | 1 VDC to 9 VDC |
| | | | 10 ohms |
| | | | Weighted shaft |
| SURPLUS | MF835 | 0.45 × 0.24 inches | 1.3 Vdc |
| TRADERS ™ | | | 100 mA |
| | | | Weighted shaft |
| MATSUSHITA ™ | V0296A | 0.24 inch diameter | 1.5 VDC |
| | | | Weighted shaft |
| SURPLUS | ME235 | 0.24 × 0.5 inches | 1.5 to 3 VDC |
| TRADERS ™ | | | 62 mA |
| | | | weighted shaft |
| PRECISION | 304-002 | 4 × 8 mm | 2.3 VDC to 3.6 VDC |
| MICRODRIVES ™ | | | 100-120 mA |
| | | | 11000 rpm |
| | | | Weighted shaft |
| PRECISION | 308-100 | 3.4 × 8 mm | 2.-3.3 V, 120 mA |
| MICRODRIVES ™ | | | 12000 rpm |
| | | | 8 mm Shaftless Vibration Motor |

In addition to electromagnetic motors and piezoelectric motors, other motor types can be used including mechanical actuators, ultrasonic motors and the like. Vibrations may be oscillating, random, directional, circular, and the like. Vibrators are well within the skill of the art, and several are described in the patent literature (and commercially available as seen above). For example, US20070299372, US20070255188, US20070208284, US20070179414, US20070161931, US20070161461, US20060287620, each incorporated by reference, describes various vibrator motors. Phased orthogonally placed linear actuators can be used to generate particular vibrational patterns.

Batteries may drive the vibrational source for some intra-oral embodiments. Small coin batteries, alkaline or lithium, are preferred due to their small size, but hydrogen batteries may also be preferred due to their power and power density, particularly as size and cost decrease with further technological development. As charged capacitors and supercapacitors become more cost effective, these may be preferred over batteries, especially since lithium batteries have been known to explode and thus may present significant regulatory challenges.

Non-traditional batteries, such as zinc-air batteries, could be used instead. Alternative power generation that is under current development, includes a water-activated battery, micro fuel cell, microbial fuel cell, etc. activated by the saliva, or even a chemical power source using the saliva to help power the vibratory force directly (versus converting electricity to motion).

For certain embodiments, a power source that can be wirelessly recharged is preferred for longer product life (e.g., US2009051312, U.S. Pat. No. 7,511,454), but in other embodiments a low cost device is manufactured that is intended to be disposable. In some embodiments, the device is charged by inductive charging or electrostatic charging. This may be particularly preferred because it eliminates the potential for corrosion and improves durability when the electronics are all enclosed, away from water or oxygen in the atmosphere, and also improves safety since everything is enclosed. Balanced against that are the increased costs, and decreased power transfer efficiency. In some embodiments, the batter is a 3.7V 110 mAh Li-Polymer Rechargeable Battery Model: 601522 available from GUANGZHOU FULLRIVER BATTERY NEW TECHNOLOGY CO (CHINA).

It is known in the art to select an appropriate power source/motor combination to provide an orthodontic vibrator that vibrates within the frequency and power suitable for orthodontic remodeling.

Any off the shelf on/off switch can be used. Particularly preferred for the intra-oral device is an on/off switch with depressible activator (push button or rocker). If the device is wirelessly activated, no on/off switch is needed. Proximity switches can be used to sense when the device is in the mouth, either through capacitance or other method. Pliable pressure sensors can also be used for activation.

Generally speaking, the vibrator(s), and optional battery, on/off switch and circuitry are placed directly on the bite plate and hermetically sealed with no extra-oral protrusions, thus allowing the most compact bite plate, preventing drooling and maximizing patient compliance. In preferred embodiments, the core may contain depressions therein for fitting various components thereinto, thus maintaining the generally planar surface of the bite plate and maintaining a thin cross section.

In other embodiments, the electronics are placed lingually, especially where additionally space is needed for the electronics. The lingual electronics can be removable, thus allowing the user to replace the electronics e.g., on battery failure, and allowing a variety of bite plate sizes to be used with the same electronic package. Preferably, the attachment of the electronics housing to the bite plate is via snap fit, and a variety of snap fit designs are provided herein.

The bite plate should have an average thickness of less than 10 mm and preferably is less than 7, 5, 4 or 3 mm (this refers to the thickness of the flat surfaces contacting occlusal surfaces of teeth and excluding rims). The various components (if any) can be placed anywhere on the bite plate, but preferably the switch is positioned near the molars (occlusal or buccal), where good contact with teeth is easily made, and the vibrators are balanced on each side of the plate (buccal or lingual). Work is in progress to determine if a single motor will suffice to vibrate both ends of the bite plate sufficiently for orthodontic remodeling, and if so, a single vibrating motor will be used. Otherwise, it is anticipated that two or possibly three motors would be used.

One or more vibrators can be placed on the plate, e.g., a single motor in the center, a pair of motors—one on each side, or one for each of three tridents or four quadrants, as shown in FIG. 1. Where more than one vibrator is used, the vibrators should be synchronized when in use, so that the vibrations do not cancel each other out. In the alternative, the various portions of the bite plate can be separated with a thin divider portion of elastomeric material that serves to dampen the vibration and prevent its transfer to another portion of the bite plate. Either embodiment can be provided with control circuitry to either synchronize the motors, or to use the motors individually, thus vibrating only certain teeth.

The bite plate itself generally contains a stiff core, such as metal or rigid plastic onto which are placed the vibrator, and optional on/off switch, battery and the circuitry, as needed to run the device. Other stiff core materials can also be employed including ceramic, polymers and resins. However, aluminum and steel may be preferred as easy to work with, inexpensive and having some flex, although certain plastic materials, such as polycarbonate, may be preferred as inexpensive and easily made by injection molding or 3D printing.

The bite plate can then be covered with a liquid-tight, polymeric material to protect the user's teeth from the metal, to isolate any electrical components, and to provide a biocompatible and pleasant mouth feel. Coatings, such as silicone rubber, polyethylene (PE), high density PE (HDPE), polycarbonate, polyurethane, polypropylene (PP), polyvinylchloride (PVC), polymethyl methacrylate, polyvinylidene fluoride, polyesters, acrylics, vinyl, nylon, rubber, latex, Teflon, or similar material, and combinations thereof may be used. A waterproof housing will also suffice.

Preferably, the coating or housing will not have an objectionable taste and will be FDA approved, such as silicone rubber, polypropylene, HDPE, and the like. In another embodiment the bite plate coating or housing and any other parts of the appliance that contact oral tissues have a selection of flavorings for additional comfort in use of the appliance.

In yet another embodiment, the device is covered with a polymer that can be reshaped for custom fit, such as boil and bite polymers, or polymers that can be activated, cured and/or set with the addition of light and/or chemicals. In yet other embodiments, the polymer is of a very soft durometer, such that it will adapt to the shape of teeth when bitten. However, the force will have to be increased with softer polymers in order for the vibration to reach the teeth.

Depending on which teeth or regions of dentition need to be treated, different bite plate shapes are possible. Given the specific orthodontic treatment plan, half bite plate targeting left or right side of the teeth, or just the front portion, can be used during different stages of the treatment.

However, a bite plate shaped for the majority of the population is preferred. Generally the bite plate is flat to allow contact of the occlusal surfaces of all teeth when the dentition has reached a final level plane and U-shaped. The bite plate preferably has one or more vertical edges or phalanges (perpendicular to the midline when positioned inside the mouth), said edges being positioned to contact the facial and optionally the lingual surfaces of the teeth (or at least a portion thereof) and possibly even apically beyond the gum line, thus providing increased circulation to the gums.

In preferred embodiments, the bite plate has a U-shaped bite plate, and is slightly tapered to be thinner in the back of the mouth to accommodate the hinged nature of the teeth. In other preferred embodiments a series of bite plates such as described in FIG. 3 are provided for different size and bite types. In yet other embodiments, a spot vibrator for treatment of a few teeth is provided. Such a variation may be beneficial, e.g., after implant surgery where increased osteogenesis is desired.

The device can be used alone, especially for post-surgical uses, but is generally used in combination with fixed appliances such as braces, or with removable appliances, such as aligners or positioners. Thus, the appliance can be used to speed bone remodeling in orthodontic uses with traditional orthodontic fixed appliances or aligner based treatments or any other appliance used for tooth movement. In other embodiments, the appliance can be used to enhance boney remodeling in periodontal and oral surgical uses.

The device herein described can be used in a variety of oral and maxillofacial applications including malocclusion, trauma repair, temporomandibular joint and muscle disorders (TMJDs), Lefort and other skeletal facial fractures, craniofacial anomalies such as boney clefts, bone defects, dentofacial deformities, dental implants, periodontal bone grafts as well as tooth, muscle, nerve, tendon, ligament, bone, and connective tissue repair.

Thus, the disclosure also includes a method for speeding the rate of movement of one or more teeth by adding a vibrational force, such as herein described, to an orthodontic force, such as provided by orthodontic devices such as aligners, braces, the Herbst and other class II or III correctors, palatal expanders, and the like. The method requires applying vibration to a bite plate, aligner or spot treatment device at frequencies between 1 to 1000 Hz (preferably 10-100 Hz, preferred 20-40 Hz or 30 Hz) and a force of 0.01-5 Newtons (or 0.1-0.5 or 0.2 Newtons) for a period of 1-60 minutes, preferably about 1-30 or 1-10 minutes or 20 minutes. This is followed by a period of recovery, ranging from 2-24 hours, preferably from 4-12 hours, and the cycle is repeated until one or more teeth are successfully moved. More particularly, the orthodontic appliance has a vibrational source capable of providing a vibratory force at a frequency of about 30 Hz and a force of about 0.2 Newtons. Excess force is generally unpleasant to the patient, especially force coupled with high frequency, and in preferred embodiments these parameters are adjustable.

The use of 30 Hz, 0.2-0.25 N for 20 minutes daily (about 70% (67%) compliance rate measured) has been clinically shown to speed tooth movement by 50%. Anything that improves the compliance rate may further speed tooth movement.

By “U-shaped” what is meant herein is that the device follow the curvature of the occlusal surfaces of the dentition, e.g., the biting surfaces of the teeth are in a substantially U-shaped curve.

By “lingually shaped, what is meant is that the device is tongue shaped (e.g., like a U that has been filled in).

By “Euro arch” or “Euro form” herein what is meant is a dentition that narrows from the molars to the incisors. In contrast, other arch forms may be much rounder, or even having parallel sides, and not begin to narrow until closer to the front of the dentition.

When we refer to contacting “the teeth” or similar phrase herein, what is meant is the entire dentition, e.g., the teeth of both arches. If less than the entire dentition is intended, it will be referred to as maxillary teeth, mandibular teeth, or a “portion” of the teeth or specific teeth or arches will be identified by name. Nevertheless, the bite plate need not contact every single tooth, since by definition some malocclusions may results in one or more teeth considerably out of alignment. The phrase also allows some leeway at the molars to accommodate the fact that dentition varies in size, and that molars erupt over 20-25 years of age, if at all, or may be removed to provide additional space for the remaining teeth, and thus most patients will not have a full set of adult teeth. Therefore, a bite plate intended to contact all teeth of the average youth patient, may not reach the molars of older or larger patients, or patients with more mature dentition.

A “bite plate” as used herein is a plate worn inside the mouth and generally contacting occlusal surfaces of the teeth, such that the device is held by the patient “biting” on the bite plate. It is not used in its more specialized meaning to refer to devices that correct deep bites by preventing the posterior teeth from touching.

By “aligner” what is meant is a single arch device made by 3D scan or cast that intimately contacts each tooth surface, wherein the position of one or more teeth is adjusted such that the device applies an orthodontic force to that tooth or teeth. Exemplary aligners are available from InvisAlign and Clear Correct. Such devices are intended to be worn at all times, removed only for eating and brushing.

When we refer to contacting “occlusal and facial surfaces of the teeth,” what is meant is that all teeth are intended to be contacted on the occlusal surface and at least one (upper or lower) facial surface, allowing of course for badly misaligned teeth that cannot be reached early in treatment. As above, the phrase also allows some leeway at the molars. If fewer facial teeth are to be contacted, such will be specified. E.g., the bite plate contacts the occlusal surfaces of the teeth, and the facial surfaces of at least the incisors, or at least incisors and cuspids, or anterior teeth, or incisors, cuspids and first premolar, or incisors, cuspids and premolars.

By “treatment modality” what is meant is a mode of action that causes an orthodontic benefit.

By “treatment modality source,” what is meant is a device or component of a device that provides the treatment modality. For example, vibration is an orthodontic treatment modality and a vibratory source provides vibration. A vibratory source could also be called a vibrator. Another treatment modality is infrared or ultraviolet light, and an LED or laser could be an exemplary light source.

A “driver” is the component that provides the treatment modality, and in preferred embodiments is a treatment modality source such as a vibrator or laser, a processor, a battery or other power source, and the wiring needed to operatively couple or operate same, contained within a waterproof housing or coating.

“Orthodontic remodeling” is used consistently with its art-accepted definition, and refers to the realigning of teeth by boney remodeling under forces sufficient to provide osteoclastic activity on the high-pressure side, and osteoblastic activity on the reduced-pressure side, but with minimal root resorption, such that teeth are gradually moved and/or realigned to a desired position.

“Orthodontic forces” is used consistently with its art-accepted definition, and refers to the steady (static) realigning forces needed for orthodontic remodeling.

“Micropulses” refer herein to the low force, low frequency vibrations that are used to speed orthodontic remodeling. The force ranges from 0.1-0.5 N and the frequency from 0.1-400 Hz. It is not yet known if significantly greater frequencies will allow faster orthodontic remodeling, but significantly heavier forces when added to orthodontic forces will likely increase root resorption.

“Orthodontic remodeling devices” or “orthodontic devices” are used consistently with art-accepted definitions, and refers to devices that provide orthodontic forces and thus the realigning of teeth. The term includes a variety of devices, such as braces, aligners, positioners, Herbst, saggital appliance, palatal expander, pendulum, Nance, and the like. The term does not include dental cleaning devices, such as electric toothbrushes, or professional cleaning tools such as scalers, and the like, or other equipment that may be used in a dental or orthodontic office.

“Micropulses” are the very small vibrations or cyclic forces that are now known to cause 50% faster orthodontic remodeling when combined with an orthodontic force.

“Headgear” is used consistently with its art-accepted definition, and refers to various head and neck attachment means used to provide orthodontic forces in a particular direction that cannot be easily be achieved with intra-oral attachment points.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated. When used in the context of part dimensions the term “about” includes that degree of tolerance that still allows the parts to operably connect, and thus will vary somewhat based on the flexibility of the material used for the part.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention. Thus, the term consisting essentially of” excludes only material elements that change the nature of the invention, such as e.g., bulky headgear, toothbrush bristles, and the like.

The invention includes one or more of the following embodiments, in any combination:

A device for faster orthodontic remodeling, said device comprising: an intra-oral vibrating bite plate,
comprising:
a substantially U-shaped surface for contacting occlusal surfaces of teeth;
said bite plate having an outside edge having upper and lower rims to contact upper and lower facial surfaces
of teeth and gums;
said bite plate having an inside edge having upper and lower rims to contact at least a portion of upper and
lower lingual surfaces of teeth and gums;
said bite plate comprising a vibratory source operably coupled to an activation button operably coupled to a
microprocessor;
said bite plate being hermetically sealed;
wherein said device is held in place during usage by teeth clamping on the bite plate and lacks other head
attachment means; and
wherein said device vibrates on activation at a single frequency selected to be between 0.1 and 400 Hz, and
results in accelerated tooth movement when used for about 20″ daily by a patient wearing an orthodontic
appliance as compared with said patient wearing said orthodontic appliance and not using said device.
A completely intra-oral vibrating orthodontic device, comprising:
a U-shaped bite plate shaped to contact occlusal surfaces of upper and lower teeth, said flat base having an
inner lingual edge and an outer facial edge and comprising a U-shaped core of material sufficiently rigid to
transmit 80% of vibration to said teeth;
at least one vibrator operatively mounted onto said core either i) between said lingual edge and said facial
edge, or ii) inside a lingual housing located at said inner lingual edge of said U-shaped bite plate, or iii) outside
said facial edge, or iv) integrated with either said facial edge or said lingual edge;
wherein said vibrator vibrates at 1-400 Hertz (Hz) and 0.1-0.5 Newtons (N);
said device being covered by a waterproof, non-conducting biocompatible polymer; and
wherein said device fits completely inside said patient's mouth with no extra-oral protruding parts.
A device as herein described wherein the vibration of a plurality of vibrators is phased so that the vibrations
add up and the device vibrates at a resonance frequency, thus reducing power demand.
A device as herein described wherein the vibration of a plurality of vibrators are oriented such that the
vibrations are in two or three planes.
A device as herein described wherein said at least one vibrator is wirelessly activatable from an extra-oral
controller.
A device as herein described wherein said at least one vibrator comprises a power source operably coupled to
an on/off switch operably coupled to a vibrating motor, or electromechanical device (e.g. motor, solenoid,
linear actuator, linear resonant actuator, etc.).
A device as herein described wherein the core has one or more depressions therein shaped for receiving said at
least one vibrator and said power source and optionally said on/off switch.
A device as herein described wherein said power source is a charge capacitor or a lithium battery or an alkaline
battery or a hydrogen battery or a wirelessly rechargeable battery.
A device as herein described wherein the core has one or more depressions therein shaped for receiving said at
least one vibrator, and/or other components.
A device as herein described wherein the core is plastic.
A device as herein described where an integrated power source is not implemented, whereas power is
supplied on-demand wirelessly with a close proximity transmitter safely through the facial/oral skin (cheeks) of
mouth cavity.
A device as herein described where all electrical components are effectively integrated into a drool guard (aka
vertical rims located near incisors) of a mouthpiece.
A device as herein described where pliable sensing elements, such as piezo electric/resistive or strain gauge,
are integrated into the bite plate in order to realize flexibility in the mouthpiece to accommodate potentially
uneven bite (malocclusion) by the user/patient.
A device as herein described where the treatment forces may be extended to three-dimensional vectors,
whereas the first two dimensions is the general plane of occlusion (bite plate) and the third dimension would
impress treatment forces that are vertical up/down with respect to the teeth and their roots.
A device as herein described where the gentle bite by the user/patient is detected by g-load measurements
sensed by an accelerometer integrated on the periphery of the mouthpiece bite plate, whereas free vibration
of the mouthpiece would have higher g-load amplitude than one being constrained by the gentle bite of the
user/patient.
A device as herein described where detection of placement inside the mouth is implemented with proximity
sensors in the drool guard of mouthpiece, but may also be integrated into the bite plate as well. These
proximity sensors may use capacitive, infrared reflective, or other sensing technologies.
A device as herein described where circular forces are replicated by equally oriented dual solenoids, linear
actuators, or linear resonant actuators with staggered actuation to administer treatment of 0.25 Newton of
circular force at 30 Hz on the occlusion plane (bite plate).
A device as herein described where the vibration element is a motor with affixed Eccentric Rotating Mass
(ERM) or protruding plunger of solenoid (or linear actuator), where some conductive material moves flush over
the surface of an integrated printed circuit board (PCB) (rigid or flexible).
A device as herein described where the movement of the vibrational element is sensed by way of capacitive
sensing utilizing the conductive copper traces intentionally designed into the PCB substrate.
A device as herein described where the detection of the physical movement of vibration element (e.g. ERM,
plunger, etc.) is used as feedback to the device's central processor to provide closed-loop speed control of the
vibration treatment.
A device as herein described where the bite plate is detachable from the Drool Guard, and perhaps rest of
Mouthpiece, to facilitate different sizes and embedded features of bite plates.
A device as herein described wherein said polymer is a medical grade polyurethane or a medical grade silicone
polymer.
A device as herein described wherein said polymer has a durometer of 60-80 Shore A or even less, e.g., about
40-50 Shore A.
A device as herein described further comprising upper and lower raised edges on said bite plate to contact
facial surfaces of upper and lower teeth.
A device as herein described wherein said a U-shaped core comprises an upper core and a lower core with one
or more depressions on one or both cores, said depressions shaped to receive said at least one vibrator such
that said at least one vibrator is protected between said upper core and said lower core.
A device as herein described wherein said at least one vibrator is inside a lingual housing and wherein said
lingual housing is reversibly attached or preferably snap fit to said bite plate.
A device as herein described wherein said core is aluminum or steel or polycarbonate.
A device as herein described wherein said upper core and said lower core are polycarbonate.
A device as herein described wherein said core has a durometer of 30-40.
An A device as herein described wherein the polymer is a polyurethane polymer or silicone polymer or
copolymers thereof.
A device as herein described wherein the width A of the bite plate ranges from 62-70 mm and the length C
ranges from 51-53 mm.
A device as herein described wherein a thickness of said bite plate is i) thicker at said center than at said two
ends and accommodates an open bite, or ii) thicker at said two ends than at said center or is thicker between
said two ends and said center and accommodates a closed bite.
A device as herein described wherein said vibrators provide less than 55 dB of noise and vibrate at a frequency
between 20-40 Hz with a variance of less than 2 Hz and a force between 0.1-0.5 Newtons with a variance of
less than 0.05 Newtons.
A device as herein described comprising a flat base sized to contact 1-3 teeth, said base having opposing side
walls for contacting facial surfaces of said 1-3 teeth, said base having a vibrator operatively mounted thereon
for vibrating at 0.1-400 Hz and 0.1-0.5 N, said vibrator being hermetically sealed.
An intra-oral orthodontic remodeling device comprising
a U-shaped upper core and a U-shaped lower core, one or both of said cores having depressions therein to
receive a battery, vibrating motor, and controls therefor,
said battery, vibrating motor, and controls mounted in said depressions and sandwiched between said upper
core and said lower core,
said upper core and said lower core coated with a biologically compatible waterproof and nonconductive
coating;
said coating being shaped to contact facial surfaces of at least a portion of teeth.
said vibrator vibrating at one frequency between 0.1-400 Hz and at one force between 0.1-0.5 N.
An intra-oral vibrating orthodontic device, comprising:
a U-shaped bite plate having a flat base shaped to contact occlusal surfaces of upper and lower teeth, said flat
base having an inner lingual edge and an outer facial edge and comprising a U-shaped core of material
sufficiently rigid to transmit vibration;
said outer facial edge having a vertical rim thereon to contact facial surfaces of upper and lower teeth;
a snap fit lingual housing reversibly mounted on said inner lingual edge of said U-shaped bite plate;
said lingual housing being waterproof and containing a vibrator operatively coupled to a power source
operatively coupled to a control chip;
wherein said intra-oral vibrating orthodontic device fits completely inside said patient's mouth with no extra-
oral protruding parts;
wherein said vibrator vibrates at 1-400 Hertz (Hz) and 0.1-0.5 Newtons (N).
A method of speeding orthodontic remodeling comprising a patient wearing a fixed orthodontic appliance
biting the bite plate of any of the devices herein described, activating said vibrator for 20 minutes, wherein
daily use allows orthodontic remodeling speed to be accelerated, and preferably increased at least 50%.

### BRIEF DESCRIPTION OF THE DRAWINGS

FIG. 1A-C shows an intra-oral bite plate in several views. View 1A is a perspective view of the core with battery, on/off switch and vibrators, where the hermetically sealed coating is omitted for clarity. Also shown in 1B is a top view of an embodiment showing polymeric dividers between various portions of the bite plate to dampen the vibration between the segments (vibrator and other components omitted for clarity). Also shown is a side view in 1C with clear coating.

FIG. 1D shows the intraoral embodiment from the parent case.

FIG. 2A-C a variant intra-oral device with snap fit central or lingual housing containing all electronics.

FIG. 3A-D. Improved bite plate designs accommodating deep, flat and open bites. Electromechanical components fitted inside the coating are omitted herein for clarity, but can be similar to e.g, FIG. 1. FIG. 3A is a top view of the bite plate; FIG. 3B-D shows side views of different variations.

FIG. 4A-1 is a perspective view of the top of another intra-oral design wherein the central housing is integral to the remainder of the bite plate (e.g. not detachable). FIG. 4A-2 is a top (outside) view, and 4A-3 is a bottom (inside) view of the device in FIG. 4A-1. FIG. 4B-1 is a perspective view of the bottom of the device, FIG. 4B-2 is a bottom (outside) view, and 4A-3 is a top (inside) view.

FIG. 5A-C shows the integration of electronic components into the core of the bite plate. FIG. 5A shows the core being divided into an upper core and a lower core; FIG. 5B shows the lower core; FIG. 5C shows the upper core. A variation in design similar to FIG. 1, but wherein the bite plate has upper and lower components and the electronics are sandwiched thereinto, preferably fitting into depressions for same. In this way, the electronics are protected from biting pressures.

FIG. 6A-B provides basic dental nomenclature and is for reference purposes only. FIG. 6A shows the nomenclature of an arc of the dentition; FIG. 6B shows different planes in relation to a tooth.

FIG. 7 shows an alternate embodiment with a pair of small, hermetically-sealed vibrator motors snap fitting to an aligner.

FIG. 8 shows another snap fit lingual vibrator, but with a much smaller footprint than that of FIG. 2 wherein two side posts allow a central frontally positioned vibrator to be snap fit to the bite plate.

FIG. 9A-B shows yet another variation of a snap fit motor mount that is designed to be used with an aligner. FIG. 9A shows one embodiment, and FIG. 9B shows an alternative embodiment. Thus, the motor mount is U-shaped, so as to convey vibration to all of the teeth and the snap fit connector is on the median line with optional wings or flanges holding the motor mount in place.

FIG. 10A-B shows a spot vibrator designed to contact one or a few teeth.

FIG. 11 shows the spring pushing back the piston in the vibrator.

FIG. 12A-B shows the firing phase of different number of vibrators. FIG. 12A shows the phase diagram of two vibrators; FIG. 12B shows the phase diagram of three vibrators.

FIG. 13A-B shows the placement of the vibrators. FIG. 13A shows the placement of two vibrators on the intra-oral orthodontic remodeling device; FIG. 13B shows the placement of three vibrators on the intra-oral orthodontic remodeling device.

FIG. 14 shows the placement of vibrators and power receptors on the intra-oral orthodontic remodeling device.

FIG. 15A-B shows different configurations of the flexible printed circuit board or “PCB” in the intra-oral orthodontic remodeling device. FIG. 15A shows the flexible PCB parallel to the occlusal plane, and FIG. 15B shows the PCB perpendicular to the occlusal plane.

FIG. 16 shows the measurement of vibration outside and inside of the mouth.

FIG. 17 shows the placement of proximity sensors, accelerometer and pliable sensors on the intra-oral orthodontic remodeling device.

### DETAILED DESCRIPTION

The following are illustrative only and not intended to limit the invention.

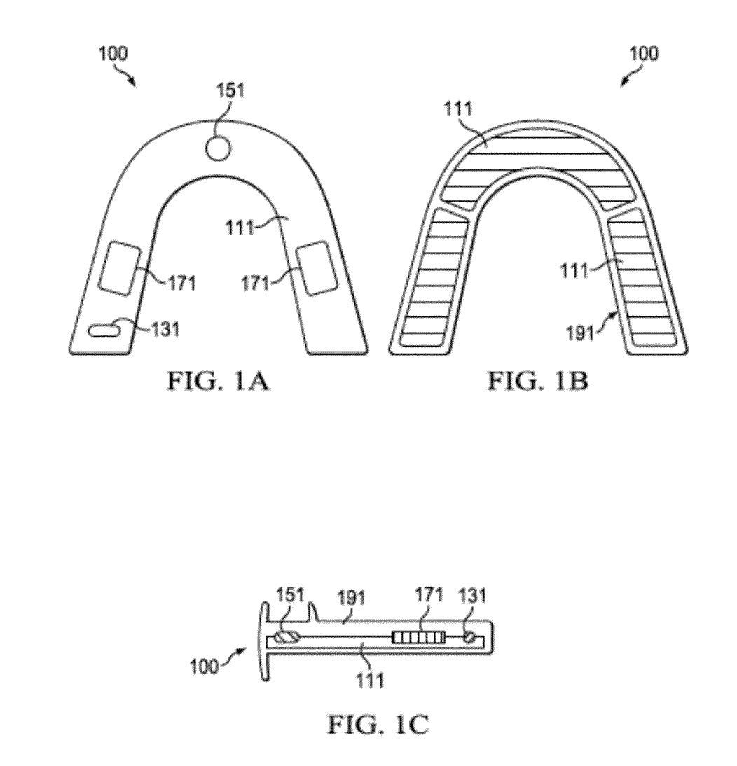

The intra-oral device 100 of FIG. 1A illustrates the core 111 having a battery 151, on/off switch 131, and two vibrators 171. The same device is shown in side view in FIG. 1C with the clear polymeric coating 191 to form the complete intra-oral vibrating bite plate. The minimum intra-oral device has an intra-oral motor, and is wirelessly activated (not shown). Thus, the switch can be omitted and the battery replaced with a receiver. However, battery and various controllers can also be provided directly in the device as shown. Further, circuitry can be added to allow this device to store usage information and communication wirelessly with an external controller (not shown). However, this will increase the size of the device and may be omitted.

Another view in FIG. 1B shows an embodiment wherein segments of the inner core 111 (here shown three) are separated by portions of a polymeric material 191 that serves to dampen vibration from one segment to the other, allowing the dental professional to vibrate 2, 3, 4, 5 or 6 segments of the device individually, thus customizing treatment for each patient. In this instance, the polymeric overcoat that seals the device is sufficiently soft and elastomeric to also provide the dampening function and thus the same material meets both needs. In other embodiments, two or more different materials are used.

In those embodiments where an external controller is provided for the intra-oral bite plate, the controller or processor can provide one or more of the following functions: 1) wirelessly power and activate the vibrators; 2) differentially activate multiple vibrators; 3) synchronize multiple vibrators to have the same frequency and timing; 4) differentially control multiple vibrators to provide different forces; 5) wirelessly charge an internal battery; 6) wirelessly download and display usage information (or transmit such information to an external display); and 7) wirelessly identify the size of the plate. Preferably, the controller has a display and is programmed to provide the dental professional with a variety of usage options via a menu and/or data entry fields, but these functions can also be provided with yet another processor (e.g., a laptop computer) having increased display space and computing power, and the initial processor merely serves as a dedicated interface between the two.

In another embodiment is shown in FIG. 1D, wherein the vibration source 30 is positioned intraorally and holds the components necessary to generate and apply the force. This embodiment can generate and apply non-static forces to either the maxillary or mandibular arch or both. This particular embodiment involves a dual arch configuration that works with both dental arches 40. The patient inserts the plate 20 into the oral cavity and bites down, holding the system 10 steady between the teeth, regardless of which of the arches 40 the device is being activated for use with. The vibration source 30 contained in the intraoral compartment 36 is activated by pushing a button 38 mounted to the housing apparatus. The vibration source could be activated by sensing the patient bite pressure as stimuli with a microprocessor 39 or some other mechanism translating the external stimuli into device function.

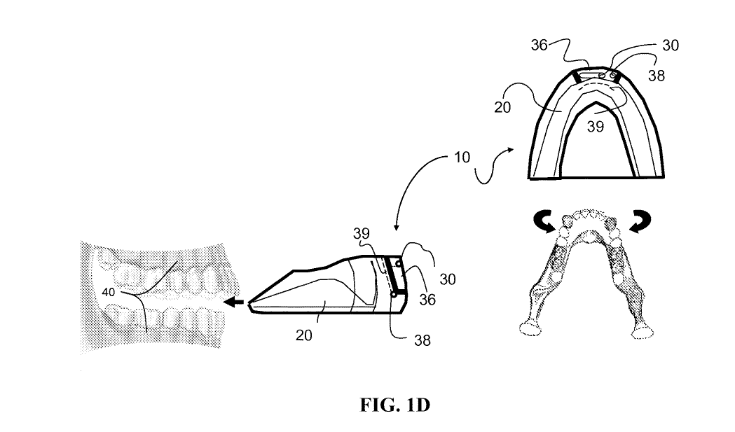

FIG. 2A and 2B show two perspectives a device with a removable central housing 26 containing all the electronics. In FIG. 2A-B show the bite plate 20 from two sides. Core 21 in outlined inside the bite plate (see also FIG. 2C for an unimpeded view), and may be optional, depending on the materials employed, but with current plastics provides a stiff core onto which a softer overcoat is molded. U-shaped base 22 has a facial side lower rim 23, and a facial upper rim 24. In this embodiment, we have omitted any lingual rims as no longer needed since the bulk of the housing will prevent the bite plate from shifting in use.

The separate snap fit lingual housing 26 with flat or slightly convex base 27, and rounded (concave) upper surface 28 (shaped to fit on top of the tongue and against roof of mouth) and snap fit rim 29 fits into matching rim depression 25 (or vice versa) on inner U-shaped rim of bite plate. The electronics are all inside the housing, but need not be detailed and are as previously described.

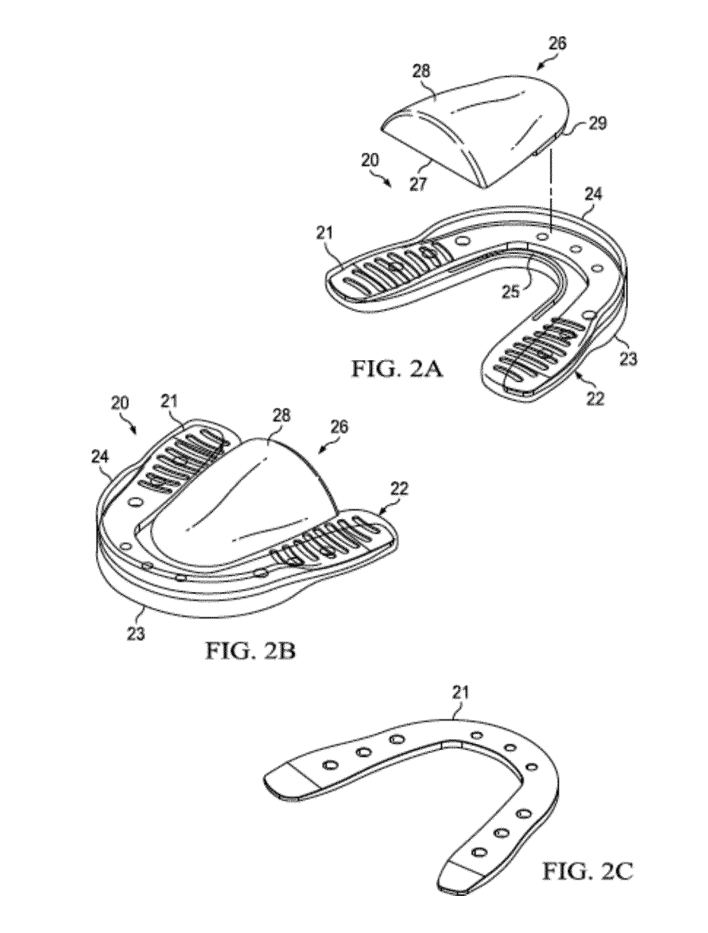

Improved mouthpieces are also provided in FIG. 3. The improved mouthpieces or bite plates are available in two sizes (small and large) based primarily on the anatomical dimensions of the patient's dental arches. Each size is available in three profiles based primarily on the type of malocclusion (open bite, deep bite and normal flat plane occlusion).

In the bite plates shown in FIG. 3, the phalanges that contact the lingual and buccal (inside and front) surface of the teeth are preferred since these edges allow greater contact with the teeth for improved comfort and improved transmission of the cyclic forces. Also shown in FIG. 3 (but not labeled) are optional ridges on the surface of the bite plate for gripping ease.

The sizes and profiles have been developed based on a statistical analysis of a sample population and are intended to allow for a maximum contact of teeth with the bite plate in a high percentage of patients and case types. The dimensions given in Table 1 are based on a minimum thickness E of 3.0-3.1 mm for the bite plate and based on using 6 sizes to fit most members of an average patient population. Obviously the final dimensions will change if the minimum thickness is changed (e.g., in an intra-oral embodiment the thickness may increase to accommodate mechanical and/or electrical components), and customized bite plates may be required for outliers.

Generally speaking, the bite plate is U-shaped. E represents the minimum thickness of the bite plate and ranges from 1-10 mm and preferably 2-5 mm or about 3 mm as in Table 1.

The thickness E increases from the ends of the U (where the molars would be when in use) towards the midline D (where the front teeth would be when in use) for use in patients having an open bite, and ranges from E to D=E+0.5-10 or more preferably 1-3 mm.

In the bite plate for the patient having a flat bite, the thickness E does not vary substantially from the molars to the anterior teeth.

For the patient having a deep bite, the bite plate is generally thicker at the molars (ends) than at the front (midline) (not shown) by 0.5-10 mm. Alternatively, the deep bite plate may have two portions of different thickness with the thicker portion being at or near the ends and the thinner portion at or near the front, but not vary within each portion (not shown). In one preferred embodiment, the thickness E increases 0.5-10 mm (or 1-3 mm) from the ends towards the middle, but then narrows and again is roughly flat at the front to accommodate the 4-6 anterior teeth.

The exterior width (perpendicular to the midline) of the U-shaped bite plate ranges from 62-70 mm and the length (along the midline) ranges from 51-53 mm. More particularly, the U-shaped plate also has an interior width B between the ends of the U and an exterior width A that includes the width of the bite plate ends. Further, the bite plate has a length C from the ends to the base of the U. In the small bite plate, the interior width B is 30-32 mm and preferably 31.8-31.9 mm, and the exterior width A is 61-63 mm, preferably 62.6-62.7 mm. The length C ranges from 51-53 mm, preferably 52.1.-52.4 mm. In the larger bite plate, B is 36-39 or about 37.7, A is 68-70 or 69.9-70, and C is 51-52 or 51.5-51.9.

TABLE 1
Optimal bite plate dimensions

| | Small (mm) | | | Large (mm) | | |
|---|---|---|---|---|---|---|
| | Open | Deep | Flat | Open | Deep | Flat |
| | Bite | Bite | Bite | Bite | Bite | Bite |
| A | 62.6 | 62.6 | 62.7 | 69.9 | 69.9 | 70.0 |
| B | 31.9 | 31.9 | 31.8 | 37.8 | 37.8 | 37.8 |
| C | 52.1 | 52.4 | 52.1 | 51.9 | 51.9 | 51.5 |
| D | 5.3 | 3.5 | 4.4 | 5.3 | 3.5 | 4.3 |
| E | 3.1 | 3.1 | 3.1 | 3.1 | 3.1 | 3.0 |

In general, the bite plate should be the smallest size possible for patient comfort without impinging on the cheeks, tongue and/or interfering with the patient's orthodontic appliances. During the course of orthodontic care the patient may require additional bite plates due to wear, change in occlusion (particularly as the treatment plan corrects maligned dentition), or continued craniofacial growth. Therefore, the fit should be reevaluated at adjustment visits, particularly if the patient complains of poor fit, discomfort or drooling.

In another embodiment, an improved vibrator has a more stable vibrator with improved performance characteristics of decreased sound and low variability frequency and force. In particular, the improved vibrator has a noise level less than 55 dB when measured at 6 inches, and preferably less than 50, 45, 40, or 35 dB. The improved vibrator provides a frequency at 20-40 Hz, preferably 30 Hz with a variance of only 2 Hz, and preferably 1 or 0.75 Hz. This is particularly important where the patient may move around during use, whereby lower quality vibrators vary substantially with motion and/or orientation and/or bite strength and thus provides an inconsistency that is irritating, less efficacious, and may make FDA clearance of such a device more difficult. Further, the improved vibrator provides force at 0.1-0.5 Newtons, and preferably at 0.2-0.25 Newtons (20-25 grams) with a variance of ±0.05 N, and preferably less than ±0.03 N.

Consistency of frequency and force is achieved herein via a feedback loop whereby motor speed is monitored and software adjusts the motor as needed. More particularly, the motor contains an integrated encoder that provides multiple high and low signal outputs per every motor revolution. The software counts the time between every encoder event and compares this to the desired target (e.g., 30 Hz). Based on this comparison, the software then adjusts the pulse width modulation that is driving the motor to increase or decrease speed as appropriate to maintain the desired speed. Accurate controlling of speed also controls the force.

A DC 6V Motor having off-set weight and 8 line integrated encoder is known to provide these characteristics, but other vibrators may also provide these performance characteristics, and can be easily tested for same. Preferably the battery is a chargeable 100 mAh Li battery. The SE8G series DC Motor, by Minebea Motor Manufacturing Corporation (Part No. SE8G0NTM) is in use already, together with a 3.7V, 110 mAh Li-PO battery by Guangzhou Fullriver Battery New Technology Co., LTD (Part no. 601522). This particular motor is large (8×8×15 mm) and thus cannot be used in the smaller footprint housings described herein, although it can be used in a lingual housing. For the on-core motors, coin motors will probably be preferred and several are available in a 10×2 mm size. The speed of such motors can be controlled by pulse width modulation.

The motor can have an integrated, built-in encoder, or a separate encoder may be used. In a preferred embodiment, a customized encoder wheel (Devicix part # 021-12-240388-01) is mounted to the motor shaft during manufacturing. The movement of the encoder is then sensed by a reflective optical sensor (Osram # SFH 9206) that is mounted to the PCB. Other suitable encoders can be chosen by persons skilled in the art.

A pilot clinical study was performed by Chung How Kau, BDS, PhD with a prototype extra-oral vibrator and bite plate, as described previously, that was set at 30 Hz, and 20 g (0.2 Newtons) for 20 minutes. The study was conducted with 17 subjects, 14 of whom completed the study. Subjects with a Class I malocclusion and at least 6 mm of lower anterior crowding were provided with the device and instructed to use it for 20 minutes daily for six months during orthodontic treatment. Other selection criteria for the study included estimated level of compliance with use of the device in accordance with the instructions and good oral hygiene. Several subjects also required extractions and space closure.

Although compliance varied from patient to patient, patients reported using the device about 80% of the time, while the device microcomputer documented an average of 67% usage. No adverse events were reported during the study, and most patients watched television, listened to music, or played video games while using the device. The most common word used to describe device use was “easy.”

A cone beam device (GALILEOS,™ by SIRONA™) was utilized to accurately measure tooth roots and to estimate any resulting root resorption, with imaging in all three planes (sagittal, axial and coronal views). The study was designed to determine if any root resorption greater than 0.5 mm occurred or if there were alterations in root lengths, and no significant losses were found.

The study also measured distances between teeth using a digital caliper. The overall distance in millimeters between the front five teeth, both upper and lower, was calculated during the alignment phase. The gap between teeth due to extractions was measured directly. The conventional wisdom regarding normal rates of tooth movement are about 1 mm of movement per month. In this study, the authors observed between 2-3 mm per month, depending on the arch in which the movement was measured (maxillary teeth being higher).

Since the above study was completed, a Phase III clinical trial has also been completed using the AcceleDent® device. This was a randomized, blinded study that followed 32 patients for up to six months. Patients had a minimum of 3 mm of extraction space that needed to be closed by moving the anterior teeth or canine distally. Patients had standard orthodontic treatment and temporary anchorage devices for tooth movement and space closure. Half the patients received a functioning device and half the patients received a sham-device. Patients used the device for 20 minutes daily; the device has a mouthpiece for the patient to lightly bite into plus a connected housing or enclosure that stays outside the mouth. The extra-oral component provided a light vibration at 0.25 Newtons and 30 Hz frequency. There were zero serious adverse events in either group, and the six month overall results showed 1.5 times (0.27/0.18=1.5) the rate of maxillary canine movement with the device.

| | | Sham (Inactive |
|---|---|---|
| | AcceleDent ® | Device) |
| Number of Participants Analyzed | 23 | 22 |
| [units: participants] | | |
| The Rate of Orthodontic | 0.27 ± 0.04 | 0.18 ± 0.04 |
| Movement of a Maxillary | | |
| Canine Tooth Being Distalized to | | |
| Close an Extraction Space. | | |
| [units: mm/week] Mean ± | | |
| Standard Deviation | | |

Note: The pilot trial by Kau was primarily alignment movement of the teeth using Little's Index, whereas the Phase III study by Pavlin measured extraction space reduction while retracting canines using TADs (after initial alignment). Thus, the two studies are not directly comparable. However, the overall conclusion is that teeth move at least 50% faster with the vibrating device than without, regardless of which type of movement is studied.

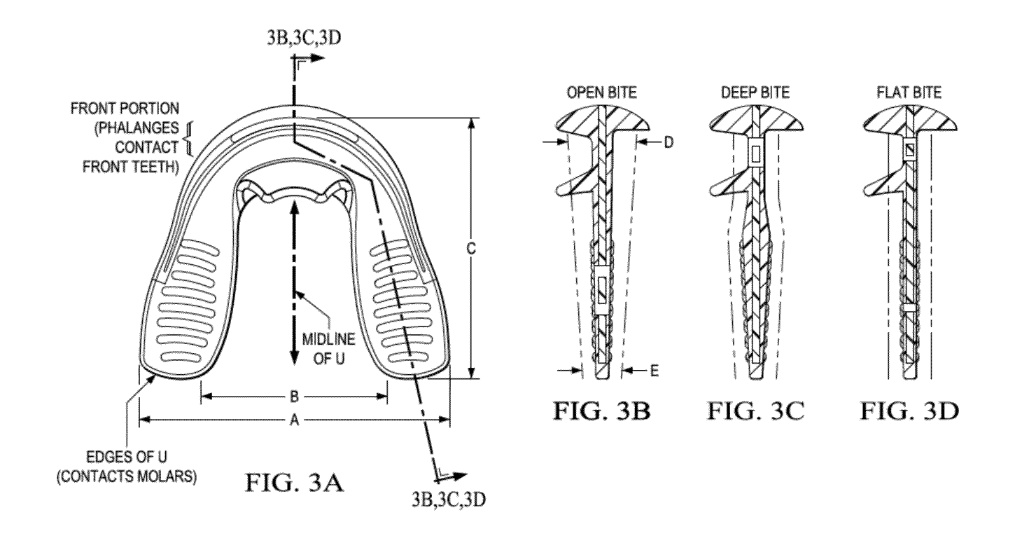

An intra-oral bite plate is shown in FIG. 4A-B, wherein FIG. 4A1-3 show the upper housing component 40 and FIG. 4B1-3 show the lower housing component 46. The central or lingual housing 42 contains the electronics (not shown), 41 is the bite plate surrounding the lingual housing 42, the outer surface of which is shown here only with ridges, but can be shaped with upper and lower facial rims as taught in U.S. Pat. No. 8,500,446. The housing 42 is raised enough to allow the motor and electronics to be contained therein (see perspective 4A-1), but is smoothly rounded to fit under the palate and is as low a profile as possible for patient comfort. The inside of the upper housing 40 is shown in FIG. 4A-3 and the underside of the bite plate 44 and interior of the housing is seen, herein smoothly rounded as well, but can be any suitable shape, including depressions and/or snap fittings for electronic components to fit into.

The lower portion of the housing 46 can be flat or slightly convex or concave, but will most likely be slightly convex to provide lingual comfort. Herein, a generally flat base is shown, wherein the outer surface of the bite plate 49 is ridged, the same as on the top component. Optional ridges 48 and 43 can be provided and allow the two components to be e.g., glued to provide a watertight exterior once the electronics are assembled thereinto.

The bottom is currently shown as flat in FIG. 4B. However, it is likely that in the final design, that the lingual portion of the housing may be raised slightly from the occlusal contacting surfaces to provide space for the patients tongue, and thus the housing will not have the completely flat bottom as shown. It is also likely, the exterior of bite plates 41, 49 will include the raised edges to contact facial teeth surfaces of both upper and lower teeth at the same tie, as is seen with the bite plate of FIGS. 1 and 2.

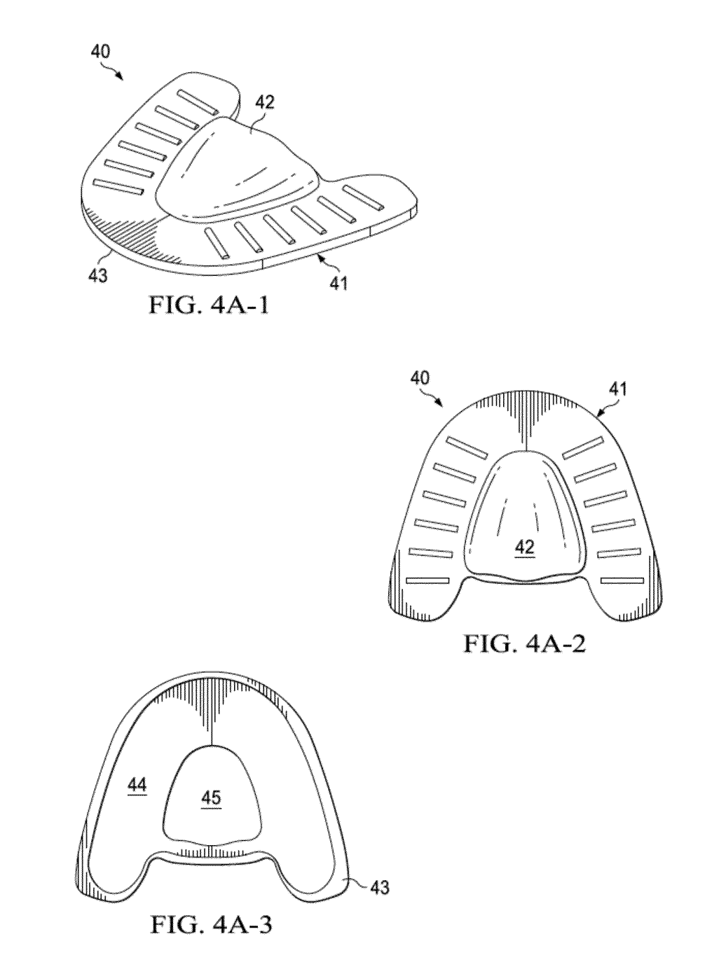

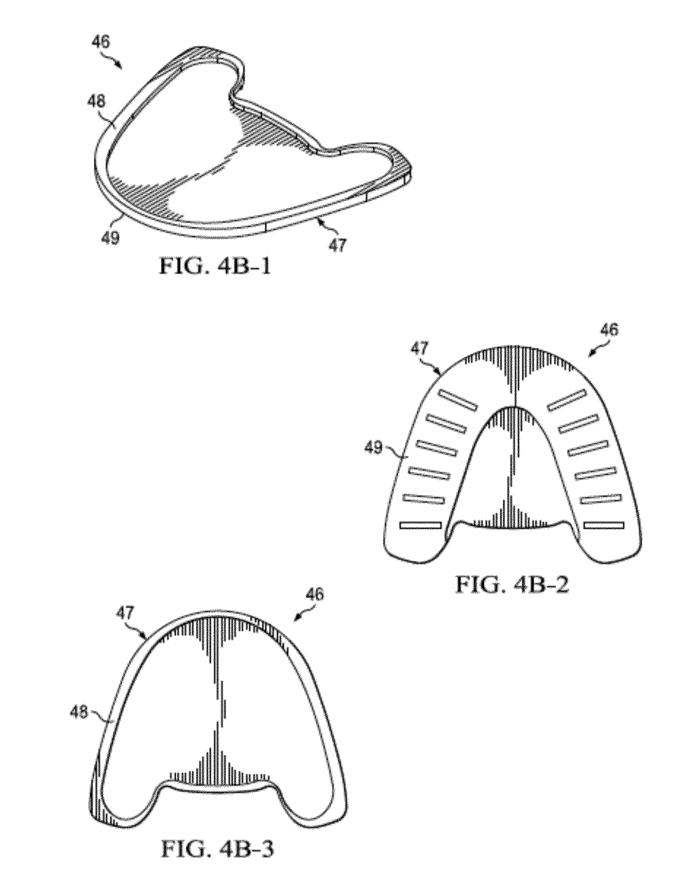

The housing design shown in FIG. 5A-C is an embodiment where the motors are directly on the bite plate, in this case including upper 54 and lower 56 components, one or both having depressions 56, 57, 58, 59 into which batteries, coin motors, on/off switches and the like can be wedged. The two components are joined together, e.g. with snap fit, weld, glue or the like and hermetically sealed to prevent water ingress.

A combination of components from FIGS. 4 and 5 (4 components—upper and lower cores 45, 56 and upper and lower housings 43, 49) has been built and allows both motors to be tested within the same prototype housing, the coin motors being placed in the small footprints or depressions available therefore, whilst the larger eccentric motor can be placed in the lingual housing 42.

The purposes of the prototype is to test various to types of motors to see which can best fulfill the following design criteria. For simplicity the prototype was made to accommodate either motor types, and one will be used with coin motors, while the other tested with offset weight motors.

| CRITERIA | CONSTRAINT |
|---|---|
| Size | 80% size reduction |
| | Volume <10 cm³ |
| Cost | Cost of construction <$50 |
| Comfort | 0-2 on Wong-Baker Pain Scale |
| Power | 2-3 year battery life |
| | >40 mA current draw |
| Frequency | 30 ± 2 Hz |
| Force Distribution | 0.25 ± 0.05 N over 3 points of contact |
| Water Resistance | No contact of electrical components with water |
| Durability | Functions after 1 m drop |

Eccentric motors are used on the current extra-oral device, but such motors are large, expensive, and need to be lingually located inside a housing, providing lingual bulk to the device. Coin motors are less expensive, small enough for placement on occlusal surfaces, and have low power needs, but such motors are only available at high rpm (1000-10000 rpm) and low force (0.05 N). However, the high rpm can be converted to lower frequency vibration by pulse width modulation.

The following components will be tested.

| COMPONENT | MODEL | STOCK # | VENDOR | COST |
|---|---|---|---|---|
| Motor | 3.0 V coin-type | 28821-ND | Digikey | $3.99 |
| | DC motor | | | |
| | 3.0 V gear | GH810514V3 | Gismo's Zone | $13.10 |
| | motor | | | |
| Battery | 110 mAh | PRT-00731 | Sparkfun | $6.95 |
| | Li-poly | | | |
| | rechargeable | | | |
| | battery | | | |
| Microcontroller | Lilypad | DEV-11190 | Sparkfun | $24.95 |
| | Arduino | | | |

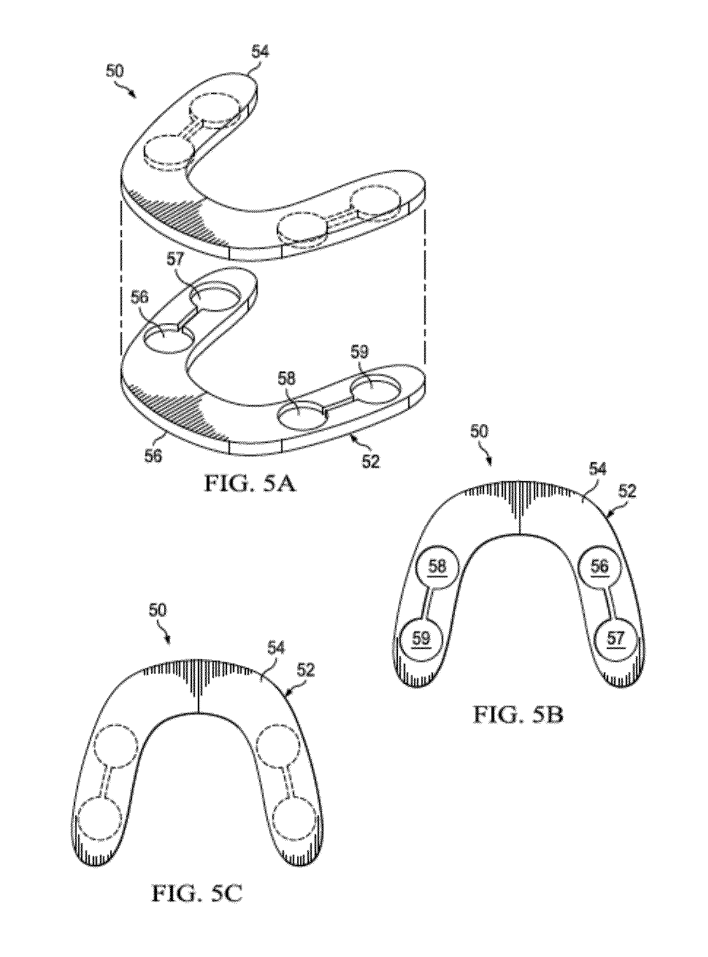

FIG. 7 shows an alternate embodiment with very small motors snap fitting to the bite plate. In this embodiment, the motors are small and inexpensive, and can easily be replaced thus obviating any need to replace the batteries and allowing a hermetically sealed disposable vibrator with no possibility of current leak. FIG. 7 shows an aligner, rather than a bite plate, but the same concept can be applied to the bites plates e.g., of FIG. 2a. Such an embodiment is extremely small, and it is expected that compliance features, motor speed controls would have to be eliminated with the current level of available technology.

Biteplate 71 has attachment points 73, Snap on button shaped housing 75 with vibrator inside to fit onto attachment points 73. Two attachments points are shown, but the device could also have one or three, as needed to convey vibration to medially and distally.

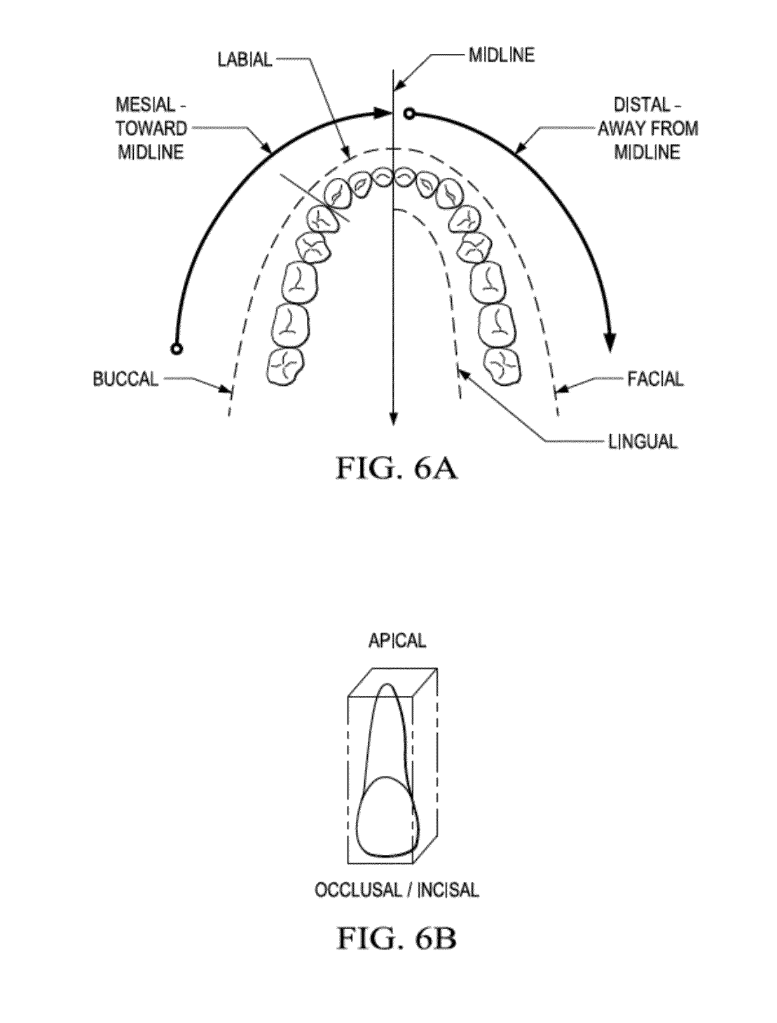

FIG. 8 shows another snap fit lingual vibrator, but with a much smaller footprint than that of FIG. 2. Here, two side posts allow a central frontally positioned vibrator to be snap fit to the bite plate.

In more detail, bite plate 81 has receptacles 83 for receiving motor mounts 89. Vibrator motor 85 is on a motor platform or housing 87 with protruding motor mounts 89 fitting into holes 83. The gender of the connections can of course be reversed, but for comfort it is preferred that receptacles are on the bite.

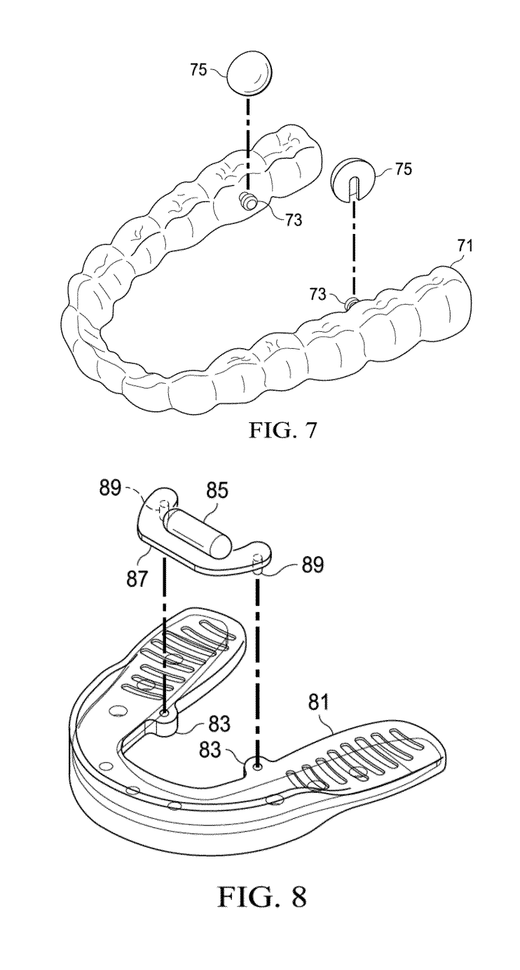

FIG. 9 shows yet another variation of a snap fit motor mount that is designed to be used with an aligner. Thus, the motor mount is U-shaped, so as to convey vibration to all of the teeth. Here the snap fit connector is on the median line and optional wings or flanges hold the motor mount in correct alignment. The same type of snap fit connector can be applied to a bite plate as in FIG. 2A. Further, the central mount can be combined with side mounts per FIG. 8 if desired.

In FIG. 9A aligner 91 has receptacle 93 thereon, herein shown as a single slot or socket on the median line, but number and placement can vary. Vibrator motor 95 is placed within motor platform or housing 97, with appropriately placed motor mounts 99 fitting into hole 93. Optional passive gripping wings 92 (aka vertical rims or edges) hold the motor mount/housing 97 in alignment with the teeth. On/off button (not seen) is combined with mount 99, such that the device is activated on insertion. Thus, U-shaped motor mount ensures that vibration is transmitted through the mount to all the teeth, yet the connection receptacle or socket 93 provides minimal impact to the aligner. Further, socket 93 can be omitted entirely (see FIG. 9B) and passive gripping wings 98 used in a central location instead. This completely eliminates the impact on the aligner, allowing the device to be used with existing aligners. We have shown the passive gripping wings pointing downwards herein, but of course this could be reversed or both upward and downward wings could be used. It is preferred, however, to minimize the materials and bulk, and thus small unidirectional edges or rims are preferred.

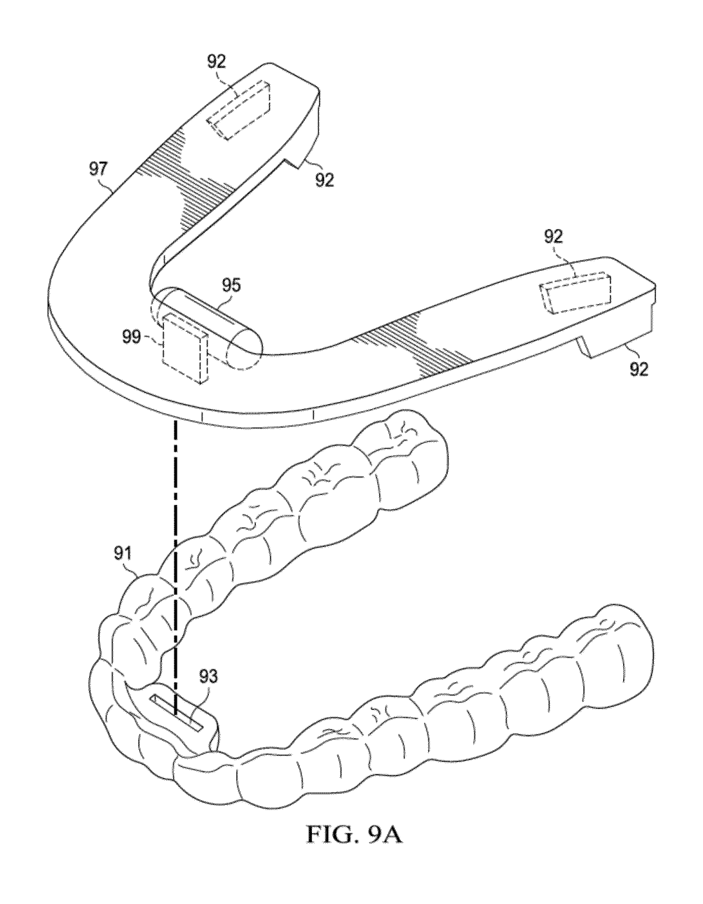

FIG. 10A-B shows a spot vibrator designed to contact one or two or a few teeth. In this embodiment, the motors are small and inexpensive, and can easily be replaced thus obviating any need to replace the batteries and allowing a hermetically sealed vibrator with no possibility of current leak. This embodiment also allows spot treatment of particular teeth, and can be combined with braces or aligners or any other fixed orthodontic appliance.

Spot vibrator 101 has a base 103 and side walls 105. On/off switch 107, battery 108 and motor 109 are housed inside the base layer 103, such that the electronics are sealed. In FIG. 10B, the spot vibrator 101 has both upper 105 and lower 106 walls.

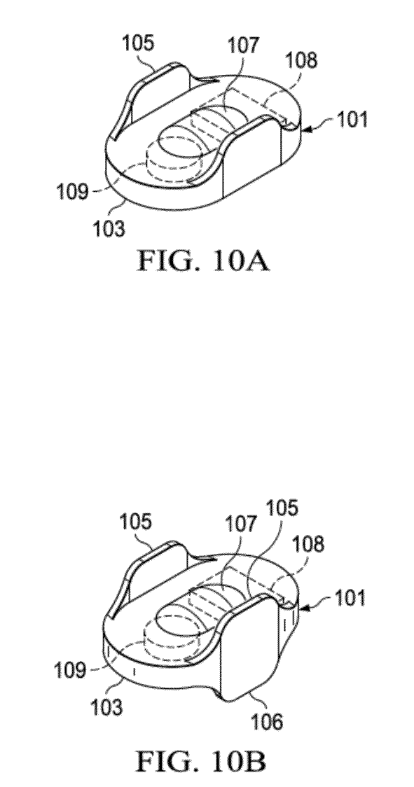

Circular force replication is carried out by equally phased dual solenoids (EPDS) where the actuation of each solenoid is staggered to produce vibration in the occlusion plane. Each actuation of an individual solenoid moves the circular vibration's force vector to a specific angle within a Cartesian plane. When the solenoid is de-activated the return spring of the solenoid will move the force vector to the opposite Cartesian angle exactly 180 degrees from the actuation angle. For example, in FIG. 12A, two solenoids are used where their respective actuation signals are staggered by 90 degrees. For the first solenoid (S1), its actuation moves the force vector to zero (0) degrees, and its de-activation moves it to 180 degrees. In similar fashion S2 has an activation/deactivation degree pair of 90 and 270 degrees respectively. As the activation and deactivation of S1 and S2 are staggered, the force vector moves from 0°, to 90°, to 180°, to 270°, then back to 360°/0°, thereby replicating a circular force.

In FIG. 12B, three solenoids are positioned with 120° angle in between, where their respective actuation signals are staggered by 60°. In this scenario circular forces are again replicated but with improved angular resolution around the Cartesian plane. If there are four solenoids, the actuation patterns should be staggered by 45°. The angle at which to stagger the solenoid actuation will always be 180° divided by the number of solenoids; stated as an equation: θ=180/N. NOTE, the solenoids illustrated in FIG. 12A and FIG. 12B have the precise orientations, the exciting signals illustrated are meant to demonstrate the phase shift only, the exact pulse shapes may vary.

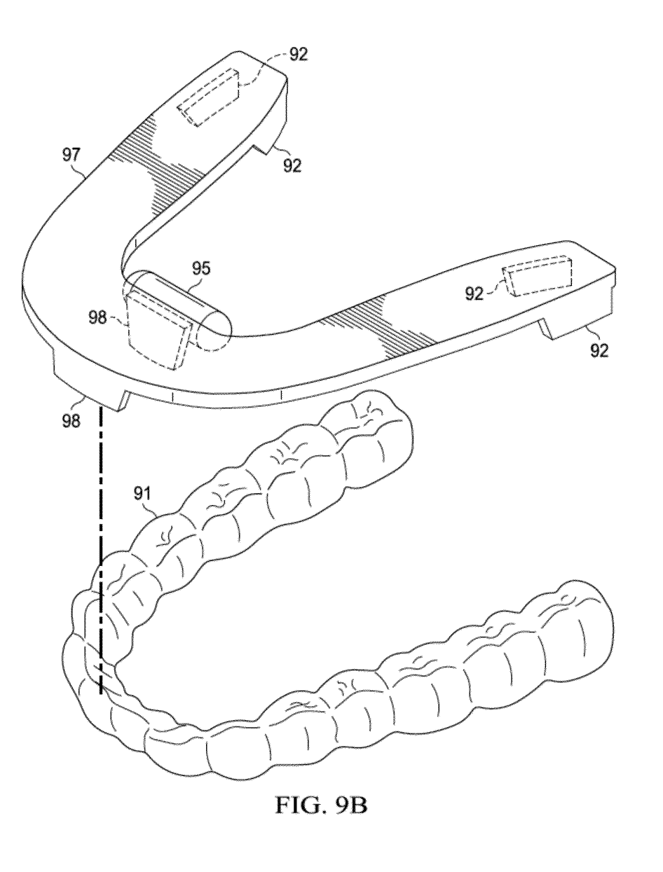

Solenoids must have response suitable for the frequency, whereas the response time of the actuation and latency of the return spring to bring its piston back to original position can be accomplished fast enough to repeat continuously at desired frequencies. Those frequencies are typically around 30 Hz, but may be as high as 400 Hz. To operate at a frequency of 30 Hz, the sum of the response time for actuation and latency of return spring cannot be longer than one-thirtieth ( 1/30) of a second. As shown in FIG. 11, force rotates about the origin to cover all 360° distributing forcing in every direction in place, where the vibration is usually created by a rotating mass. Some circular forces can be replicated by EPDS, where each solenoid is actuated at the desired frequency, but staggered equally within the firing period (T).

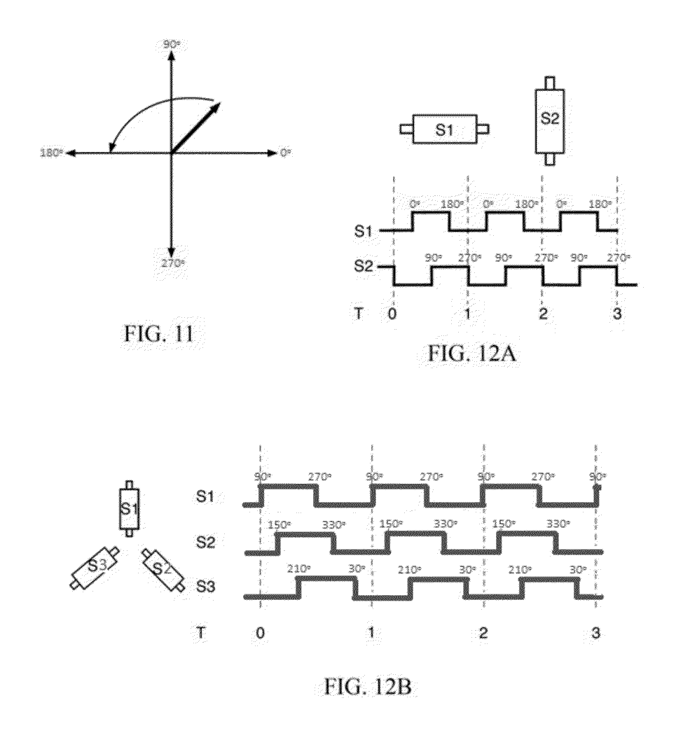

FIG. 13 shows the examples of the solenoid placements. FIG. 13A shows the two eccentric rotating mass (ERM) 1301 placed on the mouthpiece 1300, and FIG. 13B shows two ERMs 1301 and an additional ERM 1303 placed on the mouthpiece 1300. Here the ERMs can be embedded in the mouthpiece bite plate and drool guard. Other placements are possible where the electronic components are rearranged for different practical reasons.

The completely intra-oral design that embeds all electronic and electromechanical components into the drool guard of the mouthpiece. These components may include: motor/solenoids or other vibrating elements; electronic artificial intelligence or microprocessors; circuit boards, either rigid or flexible ones; wireless communications; battery cell; and power components. Such design requires wireless charging and the bite plate may be made detachable to accommodate long term usage to replace it. For example, the size of the bite plate may change when the patient grows up during the remodeling process.

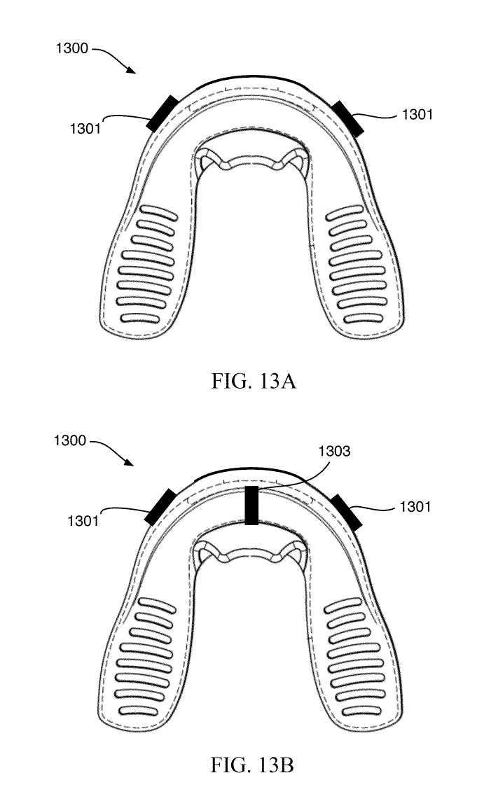

FIG. 14 shows other possible placement of the vibrators as well as wireless power receivers. In this figure, square box 1403 indicates the possible locations where the vibrators may be located, whereas the circles 1401 indicates the possible locations of wireless power receptors.

Vibration elements may be singular or may embody multiple dual vibration elements inside the aligner tray. Portions of the tray would have power receptors, or may embody multiple dual vibration elements on aligner tray. The power receptors can be of magnetic or electromagnetic, ultrasonic, infrared, electrostatic or capacitive type. Persons having ordinary skill in the art can readily implement these power receptors following the teachings of this disclosure.

Vibration element may be any type of motor, linear actuator, solenoids, or other electromechanical device. The aligner tray as shown does not include any batteries or energy storage device, but uses the wireless power receptors to receive power and then subsequently deliver power to vibration elements also embedded inside the aligner tray. An alternative design can employ power transmitters to use permanent magnets to connect to the aligner tray through the facial cheek of the mouth's oral cavity. In this setting, the aligner tray would have a minimal amount of ferromagnetic material to align power transmitter to wireless power receptors through facial cheeks.

The embedded components of the bite plate may be integrated electrically with the flexible printed circuit board (PCB) or one or more rigid PCBs. The vibration elements most likely are solenoids or linear actuator in order to minimize the thickness of the bite plate. Orthodontic aligner trays, like the one made by InvisAlign® that is manufactured with embedded vibration element, can include necessary circuitry to be powered wirelessly for treatment.

Flexible PCB and/or wires are embedded in the aligner tray to connect all embedded components to implement a functional aligner. The vibration elements, magnetic material, wireless power receptors may be in the top, bottom or both sides of the aligner trays. In one embodiment, all components are molded directly into the tray. The close proximity of the power transmitter can provide wireless power “on demand” through the facial cheeks. For example, permanent magnets in the power transmitter would allow for hand-free treatment.

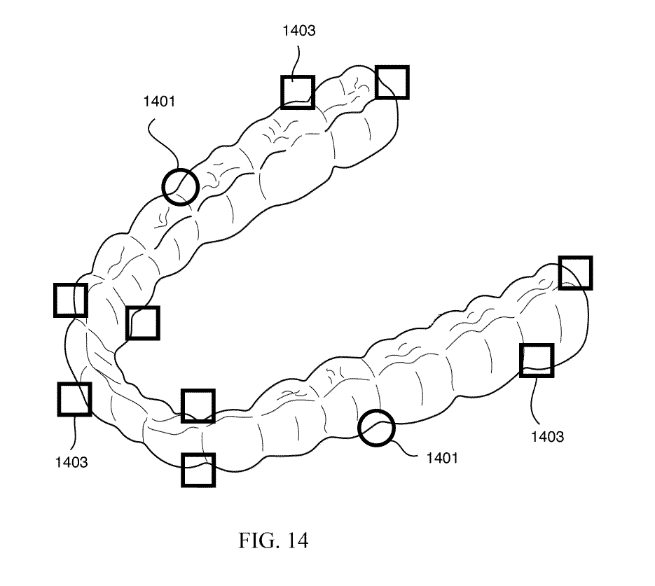

The PCB can be embedded horizontally or vertically with respect to the mouthpiece drool guard. The capacitive sensing is becoming increasingly common in microprocessor platforms, therefore a person of ordinary skills can readily implement the capacitive sensing mechanism in the mouthpiece. The motor can be placed with various relations to the PCB so long as the design can be completely intra-oral during use. FIG. 15A-B shows possible placement of the PCB inside the mouthpiece. FIG. 15A shows a PCB 1503 having, among others, an eccentric rotating mass (ERM) 1505 and a motor 1507 mounted thereon. The PCB 1503 is integrated in to the mouthpiece 1501 such that the PCB 1503 is part of the bite plate. FIG. 15B shows an alternative configuration, where the PCB 1513, on top of which an ERM 1515 and a motor 1517 is mounted, is enclosed with the mouthpiece 1511. These and other configurations are possible, as long as sufficient water-resistance is provided to the PCB and its components.

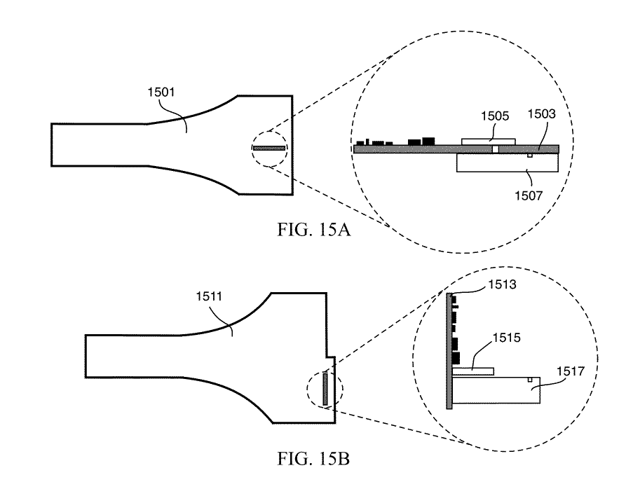

The detection of vibration in the mouth may be accomplished with a variety of sensing solutions. For example, accelerometer measuring G-load on periphery of the mouthpiece. As shown in FIG. 16, the higher G-load amplitude is detected outside the mouth, whereas the G-load is expected to dampen with gentle bite by the user. The proximity sensor (e.g. capacitive, IR reflective, etc.) in the drool guard detects proximity of gums and/or teeth when placed in the mouth.

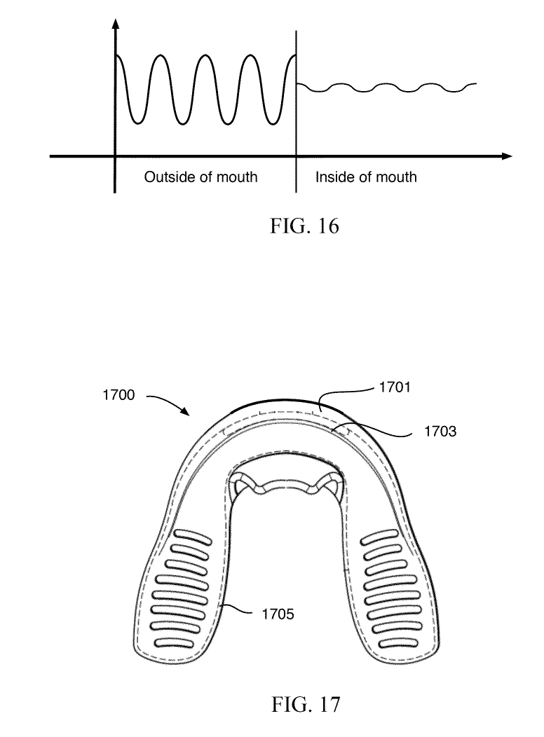

Soft and pliable pressure sensors are essential elements in wearable electronics which have wide applications in modern daily lives. Pliable sensing elements are thus readily available and can be placed inside or on the direct periphery length of bite plate. Examples of pliable sensing elements include strain gauges, or composed with piezoelectric or piezo-resistive materials that can detect slightest movement. These existing technologies can detect even the most slight compression, flex or torsion of the mouthpiece, therefore can be used to detect the use of the device. For practical reasons, any one or combination of these sensing solutions may be used. As shown in FIG. 17, the proximity sensor 1701 is embedded in the labial rim, the accelerometer 1703 is placed at the perimeter of the bite plate, whereas the pliable sensing elements 1705 are embedded in the bite plate 1700 in direct contact with the occlusal surfaces.

The AcceleDent Classic and Aura only provide treatment in 2-dimensions, i.e. the 2-D plane of the occlusion of the bite plate. However, it is possible to provide vibrational treatment force in all three dimensions. The 3rd dimension of force could be vertically oriented with respect to the dentition. This 3rd dimensional force is generally eliminated to prevent vibration vertically into teeth and their roots.

Unless a custom/eccentric gearing mechanism is used, only 1 ERM cannot generate the treatment force in 3D. For simplicity, two ERMs are used to generate 3D forces along all three axes, but if special gearing on the motor shaft is provided to change the direction of the rotation, only one ERM may be used.

3D force profile can also be realized with three or more equally-phased solenoids or linear actuators. For example, referring back to FIG. 13B, the ERM 1303 exerts vibrations on a different plane than the other two ERMs 1301. This approach is not implemented in any prior product, but can replicate the circular forces intrinsic to the ERM. 3D forces may be generated through other mechanisms. Inventors believe the 3D forces may be more effective than the 2D approach at accelerating orthodontic treatment.

The following references are expressly incorporated in their entirety:
US20060287620
US20070103016
US20070161461
US20070161931
US20070179414
US20070208284
US20070255188
US20070299372
US20080129130
US20080227046
US20090051312
US20090058361
US20090224616
U.S. Pat. No. 4,244,688
U.S. Pat. No. 4,348,177
U.S. Pat. No. 4,382,780
U.S. Pat. No. 5,030,098
U.S. Pat. No. 5,554,971
U.S. Pat. No. 5,780,958
U.S. Pat. No. 5,967,784
U.S. Pat. No. 6,632,088
U.S. Pat. No. 6,684,639
U.S. Pat. No. 6,832,912
U.S. Pat. No. 6,870,304
U.S. Pat. No. 7,029,276
U.S. Pat. No. 8,152,521 by Yamamoto

JP2004321498 by Yamashiro
WO2001078217.

1. A device for faster orthodontic remodeling, said device comprising:
a) an intra-oral vibrating bite plate, comprising:
i) a substantially U-shaped surface for contacting occlusal surfaces of teeth;
ii) said bite plate having an outside edge having upper and lower rims to contact upper and lower facial surfaces of teeth and gums;
iii) said bite plate having an inside edge having upper and lower rims to contact at least a portion of upper and lower lingual surfaces of teeth and gums;
iv) said bite plate comprising a vibratory source operably coupled to an activation button operably coupled to a microprocessor;
v) said bite plate being hermetically sealed;
i) wherein said device is held in place during usage by teeth clamping on the bite plate and lacks other head attachment means; and
b) wherein said device vibrates on activation at a single frequency selected to be between 0.1 and 400 Hz, and results in accelerated tooth movement when used for about 20″ daily by a patient wearing an orthodontic appliance as compared with a similar patient not using said device.

2. The device of claim 1, wherein said device vibrates between 20 and 30 Hz and at a force selected to be between 0.1 and 0.5 N.

3. The device of claim 1, wherein said device vibrates at 30 Hz and 0.2 N.

4. The device of claim 3, wherein said accelerated tooth movement is about 50% faster.

5. The device of claim 1, said vibratory source operatively mounted i) onto an occlusal surface of said core or ii) on a buccal or lingual surface of said bite plate, or iii) inside a lingual housing located at said inner lingual edge of said U-shaped bite plate.

6. The device of claim 1, further comprising an inner core having depressions to receive said vibratory source and said microprocessor, said inner core being coated with a biocompatible polymer.

7. The device of claim 1, further comprising an inner core having depressions to receive said vibratory source and said microprocessor, said inner core being coated with a biocompatible polymer, wherein said device vibrates between 20 and 30 Hz and at a force selected to be between 0.1 and 0.5 N.

8. The device of claim 1, further comprising an upper inner core and a lower inner core, one or both cores having depressions to receive said vibratory source and said microprocessor therebetween, said upper and lower inner core being coated with a biocompatible polymer.

9. A method of accelerating tooth movement, said method comprising:
a) a patient wearing an orthodontic appliance biting the device of claim 7 and activating said device for about 20 minutes a day;
b) said method resulting in 50% faster tooth movement as compared with said patient wearing said orthodontic appliance and not using said device.

10. A completely intra-oral vibrating orthodontic device, comprising:
a) a U-shaped bite plate shaped to contact occlusal surfaces of upper and lower teeth and having an upper facial rim and a lower facial rim;
b) said bite plate comprising a U-shaped core of material sufficiently rigid to transmit 80% of vibration to said teeth;
c) at least one vibrator operatively mounted i) onto an occlusal surface of said core or ii) on a buccal or lingual surface of said bite plate, or iii) inside a lingual housing located at said inner lingual edge of said U-shaped bite plate;
d) wherein said vibrator vibrates only between 1-400 Hertz (Hz) and between 0.1-0.5 Newtons (N);
e) said device being covered by a waterproof, non-conducting biocompatible polymer; and
f) wherein said device fits completely inside said patient's mouth with no extra-oral protruding parts.

11. The device of claim 10, wherein said at least one vibrator is wirelessly activatable from an extra-oral controller.

12. The device of claim 10, wherein said at least one vibrator comprises a power source operably coupled to an on/off switch operably coupled to a vibrating motor.

13. The device of claim 12, wherein the core has one or more depressions therein shaped for receiving said at least one vibrator and said power source.

14. The device of claim 12, wherein said power source is a charge capacitor or a lithium battery or an alkaline battery or a hydrogen battery or a wirelessly rechargeable battery.

15. The device of claim 12, further comprising a wireless power receiver operably coupled to said power source.

16. The intra-oral vibrating orthodontic device of claim 10, wherein at least two vibrators is operably mounted on said core.

17. The intra-oral orthodontic device of claim 16, wherein said at least two vibrators vibrate in a phase selected so that said bite plate vibrates at a resonance frequency.

18. The intra-oral vibrating orthodontic device of claim 17, wherein said at least two vibrators are located near a left premolar and near a right premolar.

19. The intra-oral vibrating orthodontic device of claim 18, further comprising a third vibrator located near a central incisor on a lingual surface of said bite plate.

20. The intra-oral vibrating orthodontic device of claim 19, wherein said third vibrator vibrates along a plane that is different from said at least two vibrators.

21. The intra-oral vibrating orthodontic device of claim 10, wherein at least one pliable sensing element is integrated into said bite plate.

22. The intra-oral vibrating orthodontic device of claim 10, wherein the core has one or more depressions therein shaped for receiving said at least one vibrator.

23. The intra-oral vibrating orthodontic device of claim 10, wherein the vibration frequency is 30 Hz+/−2 Hz, and the vibration force is 0.2 Newtons+/−0.03 Newtons.

24. The intra-oral vibrating orthodontic device of claim 10, wherein said vibrator vibrates at 0.2 Newton and 30 Hz.

25. The intra-oral vibrating orthodontic device of claim 10, wherein said U-shaped core comprises an upper core and a lower core with one or more depressions on one or both cores, said depressions shaped to receive said at least one vibrator such that said at least one vibrator is protected between said upper core and said lower core.

26. The intra-oral vibrating orthodontic device of claim 10, wherein said at least one vibrator is inside a lingual housing and wherein said lingual housing is reversibly attached to said bite plate.

27. The intra-oral vibrating orthodontic device of claim 10, wherein said at least one vibrator is inside a lingual housing and wherein said lingual housing is reversibly snap fit to said bite plate.

28. An intra-oral orthodontic remodeling device, comprising:
a) a U-shaped upper core and a U-shaped lower core, one or both of said cores having a plurality of depressions on an occlusal surface;
b) a battery, two vibrating motors, and controls mounted in said depressions and sandwiched between said upper core and said lower core;
c) said upper core and said lower core coated with a biologically compatible waterproof and nonconductive coating;
d) said coating being shaped to contact upper and lower facial surfaces of at least a portion of teeth;
e) said vibrator motor vibrating at a single frequency between 0.1-400 Hz and at a single force between 0.1-0.5 N;
f) wherein said intra-oral vibrating orthodontic device fits completely inside said patient's mouth with no extra-oral protruding parts.

29. An intra-oral vibrating orthodontic device, comprising:
a) a U-shaped bite plate having a flat base shaped to contact occlusal surfaces of upper and lower teeth, said flat base having an inner lingual edge and an outer facial edge and comprising a U-shaped core of material sufficiently rigid to transmit vibration;
b) said outer facial edge having a vertical rim thereon to contact facial surfaces of upper and lower teeth;
c) a snap fit lingual housing reversibly mounted on said inner lingual edge of said U-shaped bite plate;
d) said lingual housing being waterproof and containing a vibrator operatively coupled to a power source operatively coupled to a control chip or processor;
e) wherein said intra-oral vibrating orthodontic device fits completely inside said patient's mouth with no extra-oral protruding parts;
f) wherein said vibrator vibrates at a frequency between 1-400 Hertz (Hz) and at a force 0.1-0.5 Newtons (N) when in use.
